(19) United States
(12) Patent Application Publication
(10) Pub. No.: US 2025/0223989 A1
(43) Pub. Date: Jul. 10, 2025

(54) Functional Element, Component Assembly and Method of Manufacturing a Component Assembly

(71) Applicant: PROFIL Verbindungstechnik GmbH & Co. KG, Friedrichsdorf (DE)

(72) Inventors: Amer Mahlme, Bad Homburg (DE); Oliver Diehl, Usingen (DE); Tobias Jene, Friedrichsdorf (DE)

(21) Appl. No.: 19/095,294

(22) Filed: Mar. 31, 2025

Related U.S. Application Data
(62) Division of application No. 17/569,001, filed on Jan. 5, 2022.

(30) Foreign Application Priority Data
Jan. 5, 2021 (DE) 102021100073.4

(51) Int. Cl. F16B 19/00

(52) U.S. Cl. CPC F16B 19/008

(57) ABSTRACT

A functional element for pressing into a workpiece comprises a functional section; and a fastening section having an abutment surface for introducing a press-in force into the functional element; a workpiece contact surface that is disposed opposite the abutment surface; and a sealing region for receiving displaced material of the workpiece, said sealing region being disposed between the workpiece contact surface and the functional section and forming a contact surface for the displaced material to seal a connection between the functional element and the workpiece.

The invention relates to a functional element for pressing into a workpiece, in particular into a sheet metal part, to a component assembly that has a workpiece having a hole, in particular a sheet metal part, and such a functional element, and to a method of manufacturing a component assembly.

Such elements usually have a functional section that in turn serves to fasten further components. They are widely used in the automotive industry, among others.

Functional elements can be bolt elements, whose shafts can be provided with a thread, or nut elements that can, for example, have an internal thread.

Functional elements are known in different designs. On the one hand, there are, for example, rivet elements that have a rivet section that is deformed on the attachment to a sheet metal part to form a rivet bead and to form a ring-shaped receiver for the margin of a hole in the sheet metal part with the head part. With such rivet elements, the functional element is therefore deformed on the attachment to the sheet metal part. Furthermore, press-in elements are known in which the element itself is not intentionally deformed on the attachment to a sheet metal part, but the sheet metal material itself is deformed to bring it into engagement with undercuts of the respective press-in element.

To seal connections between functional elements and workpieces, in particular sheet metal parts, a coating provided for this purpose is usually applied to parts of the functional elements that contact the workpiece. The application takes place in a separate manufacturing step that leads to an increased effort and thereby to higher costs and an increased time requirement. In addition, this solution causes an increased environmental impact due to the coating.

It is an object of the present invention to provide a functional element and a component assembly by which a tight connection can be achieved with comparatively little effort and a reduced environmental impact can be achieved compared to previously known solutions.

This object is satisfied by the subjects of the independent claims. Advantageous embodiments are the subject of the dependent claims.

A functional element in accordance with a first aspect of the invention is suitable for being pressed into a workpiece, in particular into a sheet metal part, and comprises a functional section; and a fastening section having an abutment surface for introducing a press-in force into the functional element; a workpiece contact surface that is disposed opposite the abutment surface, that can be brought into contact with the workpiece, and that is in particular of a flange-like design; and a sealing region for receiving displaced material of the workpiece, said sealing region being disposed between the workpiece contact surface and the functional section in an axial direction and/or a radial direction of the functional element. The sealing region forms a contact surface for the displaced material to seal a connection between the functional element and the workpiece, wherein the contact surface has a first part surface, which extends obliquely to the axial direction of the functional element and which converges viewed in a press-in direction of the functional element, and a second part surface that adjoins the first part surface, that extends obliquely to the axial direction of the functional element, and that diverges viewed in the press-in direction of the functional element.

The second part surface directly or indirectly adjoins the first part surface.

Due to the converging first part surface and the diverging second part surface, which adjoins the first part surface, the contact surface is formed that is designed such that the displaced material of the workpiece can be optimally pressed against the contact to achieve a high tightness.

The functional element can in particular be a press-in bolt, in particular a press-in bolt having a flange, or a nut element, said press-in bolt and nut element preferably being used with ductile sheet metal parts to facilitate the press-in process. In this respect, in the press-in bolt, the shaft preferably has an external thread and forms the functional section. The nut element, in contrast, preferably has an internal thread that forms the functional section. Instead of the threads, other features can also be provided that are e.g. suitable for fastening a further component or for providing another functionality. The functional section can also be sectionally or completely formed as a smooth pin or a smooth hole. The fastening section is the section of the functional element with which the functional element is fastened to the workpiece.

The press-in direction designates the direction in which the functional element is pressed into the sheet metal part. The press-in direction can in particular extend in the direction of the axial direction of the functional element, and indeed preferably from the abutment surface in the direction of the workpiece contact surface. The abutment surface and/or the workpiece contact surface expediently preferably extends/extend approximately perpendicular to the press-in direction for the purpose of an effective force introduction.

The functional section and the fastening section are preferably formed in one piece. The functional element and/or the workpiece can be composed of metal. However, the concept in accordance with the invention can also be implemented with elements and/or workpieces composed of other materials.

The functional element can generally be self-punching.

Advantageous embodiments of the invention are set forth in the claims, in the description, and in the enclosed drawings.

The first part surface is preferably inclined approximately 20° to approximately 40°, in particular approximately 30°, with respect to the axial direction. The first part surface thereby has a comparatively small inclination with respect to the axial direction such that the material of the workpiece can be pressed tightly against the first part surface.

In a preferred embodiment, the second part surface is inclined approximately 50° to approximately 70°, in particular approximately 60°, with respect to the axial direction. The second part surface is thereby comparatively strongly inclined with respect to the axial direction, whereby an undercut can also be formed by means of the second part surface in addition to the sealing function. The functional element is thereby securely held in or at the workpiece.

The first part surface and the second part surface can in particular extend approximately at a right angle to one another.

The first part surface and/or the second part surface can expediently be conical such that they each form a surface against which the material of the workpiece can be tightly pressed.

The first part surface is preferably connected to the second part surface by a rounded transition region to avoid hollow spaces at the transition from the first part surface to the second part surface and leaks resulting therefrom. A radius of the curvature of the transition region can in particular be in the range of approximately 0.5 mm or less, in particular approximately 0.25 mm to 0.35 mm.

A functional element in accordance with a further aspect of the invention is suitable for pressing into a workpiece, in particular into a sheet metal part, and comprises a functional section and a fastening section having an abutment surface for introducing a press-in force into the functional element; a workpiece contact surface that is disposed opposite the abutment surface, that can be brought into contact with the workpiece, and that is in particular of a flange-like design; and a sealing region for receiving displaced material of the workpiece, said sealing region being disposed between the workpiece contact surface and the functional section in an axial direction and/or a radial direction of the functional element. The sealing region forms a contact surface for the displaced material to seal a connection between the functional element and the workpiece, wherein the fastening section has a projection that bounds the sealing region in the axial direction and that has a first flank facing the sealing region and a second flank that is remote from the sealing region and that extends obliquely and inclined to different degrees with respect to the axial direction.

The projection can in particular in the peripheral direction be provided peripherally at the shaft of a functional element designed as a bolt element and can also be designated as a lip. The projection preferably projects radially outwardly and comprises at least the first flank and the second flank. The first flank can in particular form at least a part of the contact surface, in particular the second part surface.

An undercut is formed by the projection, said undercut terminating the sealing region and securely holding the functional element in the workpiece. The displaced material of the workpiece can thereby be enclosed in the axial direction between the workpiece contact surface or the contact surface, on the one hand, and the projection, on the other hand. At the same time, the projection, in particular the first flank, can also form a part of the contact surface to achieve a high sealing effect.

The first flank is preferably more inclined with respect to the axial direction than the second flank. The effect of the undercut, that is the hold of the functional element in the workpiece, is thereby improved, on the one hand, and, on the other hand, the insertion of the functional element is facilitated on the pressing of the functional element into the workpiece in the press-in direction in which the second flank projects.

The first flank can in particular be inclined approximately 50° to approximately 70°, in particular approximately 60°, with respect to the axial direction.

In a preferred embodiment, the second flank is inclined approximately 15° to approximately 35°, in particular approximately 25°, with respect to the axial direction.

The first flank and the second flank can expediently be connected to one another by a connection section in which the projection has a constant diameter such that the design of the projection can be adapted to the circumstances, in particular of a sheet metal thickness of the workpiece, without impairing the function of the flanks. In this embodiment, the connection section thus extends in the axial direction. The connection section can preferably extend over approximately 20% to approximately 70%, in particular approximately 40%, of the axial extent of the projection.

The fastening section, for example the workpiece contact surface, in particular has at least one feature providing security against rotation. A plurality of features providing security against rotation are preferably provided that are, for example, arranged uniformly distributed in the axial direction and/or the peripheral direction. It can be ensured by the features providing security against rotation that a connection of the functional element to the workpiece can withstand a torque load subsequently introduced via the functional section. The features providing security against rotation can be arranged in a recess or a peripheral groove of the fastening section, in particular of a head of the functional element that comprises the abutment surface and/or the workpiece contact surface.

The features providing security against rotation can be configured as radially and/or axially extending ribs or grooves. The features providing security against rotation are in particular uniformly arranged and extend at equal angular spacings from one another in the radial direction.

The workpiece contact surface can have a recess, in particular a ring recess, with the first part surface preferably being able to extend into the recess and/or merge into it.

In accordance with an embodiment, the workpiece contact surface has—in addition or alternatively to the recess—an elevated portion. The elevated portion can at least sectionally be of wedge-shaped design viewed in a cross section. The wedge shape preferably slopes toward the first part surface. The first part surface can merge into the elevated portion.

One function of the elevated portion can be to assist in a displacement of material of the workpiece into the sealing region on a cooperation of the element with the workpiece.

The features providing security against rotation—if present—can be arranged in the recess and/or at the elevated portion.

The recess can in particular be directed opposite to a press-in direction of the functional element such that the material of the workpiece is displaced, at least partly, on the pressing into the recess and is there in particular pressed against the first part surface of the contact surface.

In an advantageous embodiment, the workpiece contact surface merges into the first part surface.

The invention further relates to a component assembly that has a workpiece, in particular a sheet metal part, wherein a functional element in accordance with at least one of the embodiments described above is pressed into a hole prefabricated in the workpiece or into a hole punched by the functional element. In this respect, the functional element in accordance with the invention is pressed into the hole such that material of the workpiece displaced by the pressing in or after the pressing in is received in the sealing region and tightly contacts the contact surface.

The displaced material of the workpiece in particular contacts the projection or at least partly or completely surrounds the projection.

A thickness of the workpiece can be smaller than or substantially equal to an axial extent of the sealing region at least in the region of the hole.

Alternatively, a thickness of the workpiece can, however, be greater than or substantially equal to an axial extent of the sealing region at least in the region of the hole.

In accordance with a further aspect, the invention further relates to a method of manufacturing a component assembly in accordance with the invention that comprises the following steps:
providing a functional element in accordance with the invention;
providing a workpiece, in particular a sheet metal part; and
inserting the functional element into a prefabricated hole in the workpiece or into a hole punched by the functional element and introducing a press-in force into the abutment surface such that the workpiece contact surface is brought into contact with the workpiece; and
displacing material of the workpiece into the sealing region such that the material is pressed against the contact surface to establish a sealed connection between the functional element and the workpiece.

In accordance with an embodiment, the functional element is self-punching such that a pre-punching of the workpiece is unnecessary.

The displacement of the material can take place by pressing a die against a surface of the workpiece remote from the workpiece contact surface. In this respect, the die is suitably designed to displace the material of the workpiece into the sealing region such that the material is pressed against the contact surface to establish a sealed connection between the functional element and the workpiece.

In the method, the workpiece is in particular disposed on a support that comprises a suitable die. The introduced press-in force then also serves to displace the material. However, it is also possible to press the die against the surface of the workpiece remote from the workpiece contact surface during or after the insertion of the functional element into the hole and/or the introduction of the press-in force in order to displace material of the workpiece.

The displacement of the material of the workpiece can also be caused by components of the head of the element during the pressing in.

The invention will be explained purely by way of example in the following with reference to advantageous embodiments. In the drawings, which schematically illustrate the embodiment examples,

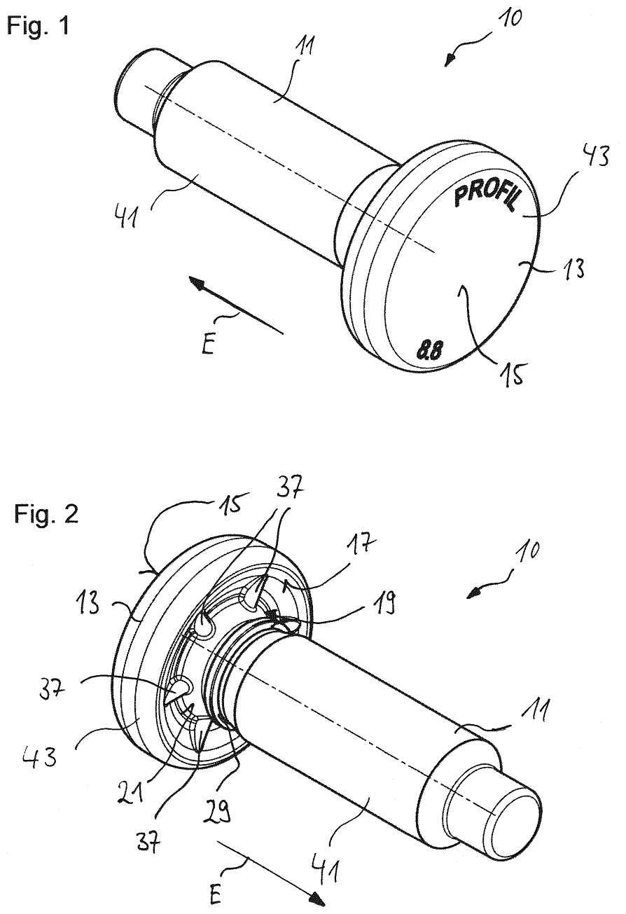

FIG. 1 shows a perspective view of a functional element configured as a press-in bolt in accordance with an embodiment example;

FIG. 2 shows a further perspective view of the functional element from FIG. 1;

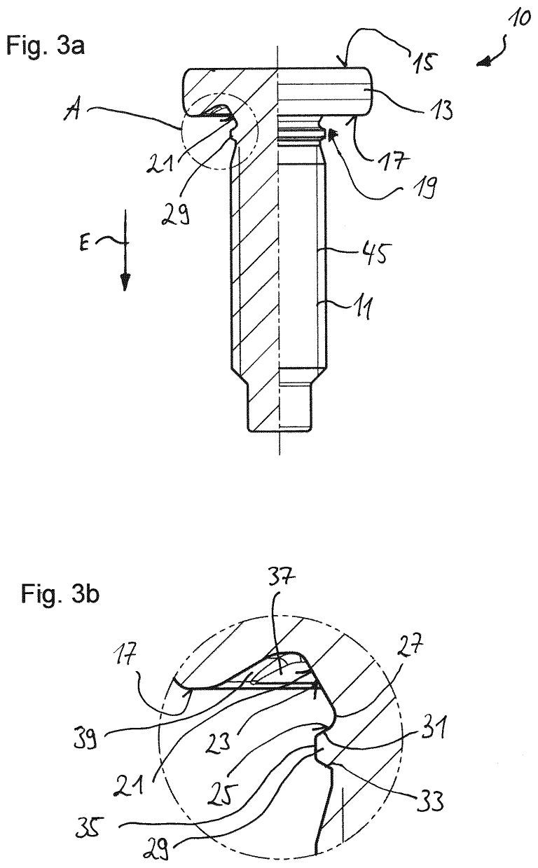

FIG. 3a shows a half-section of the functional element from FIG. 1;

FIG. 3b shows a detailed view of the region A in accordance with FIG. 3a;

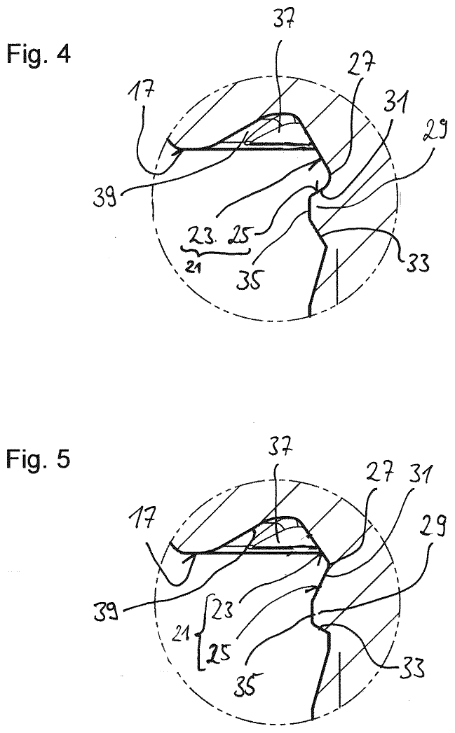

FIG. 4 shows a detailed view of a sealing region of a functional element configured as a press-in bolt in accordance with a further embodiment example;

FIG. 5 shows a detailed view of a sealing region of a functional element configured as a press-in bolt in accordance with a further embodiment example;

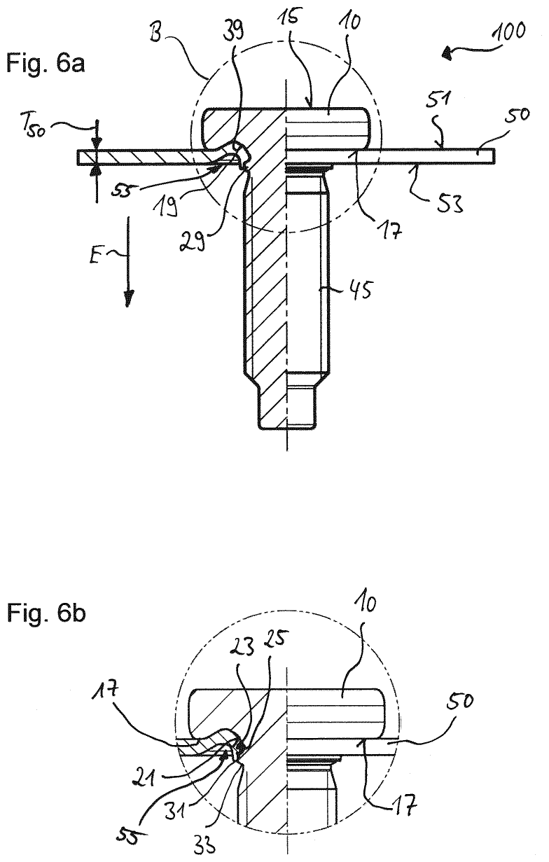

FIG. 6a shows a half-section of a component assembly in accordance with an embodiment example with a press-in bolt as the functional element;

FIG. 6b shows a detailed view of the region B in accordance with FIG. 6a;

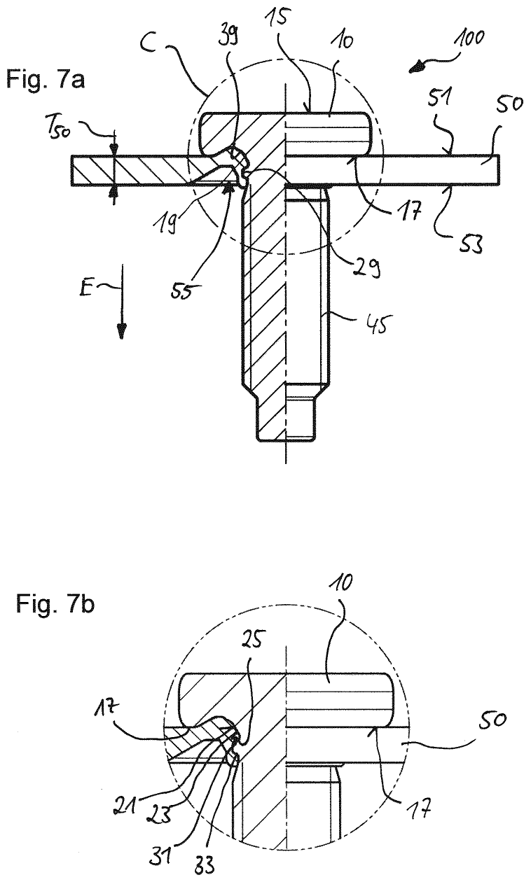

FIG. 7a shows a half-section of a component assembly in accordance with a further embodiment example with a press-in bolt as the functional element;

FIG. 7b shows a detailed view of the region C in accordance with FIG. 7a;

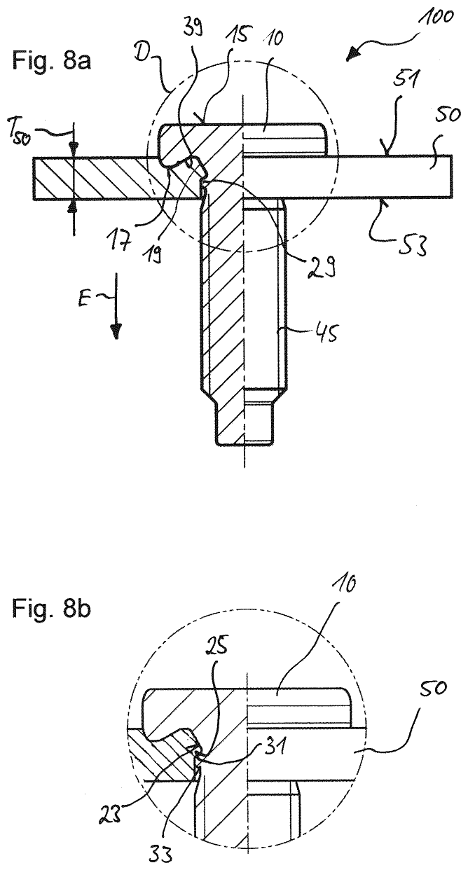

FIG. 8a shows a half-section of a component assembly in accordance with a further embodiment example with a press-in bolt as the functional element;

FIG. 8b shows a detailed view of the region D in accordance with FIG. 8a;

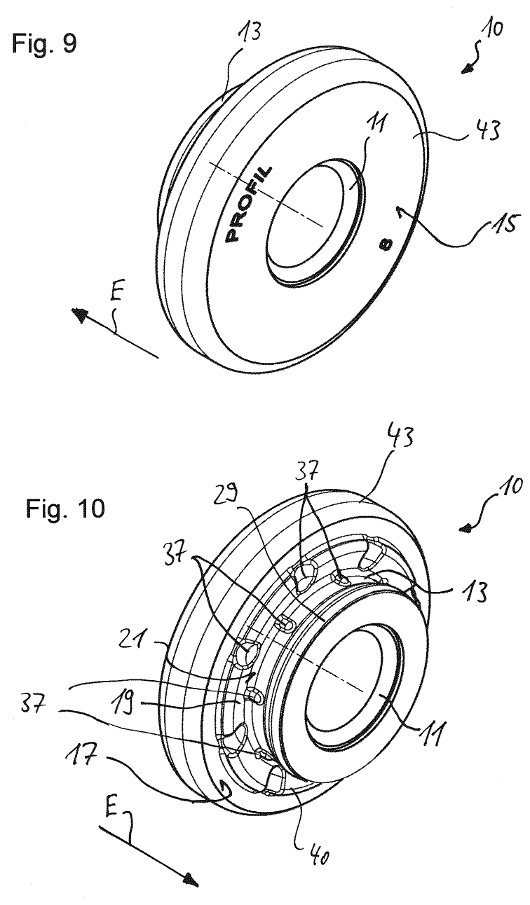

FIG. 9 shows a perspective view of a functional element configured as a nut element in accordance with an embodiment example;

FIG. 10 shows a further perspective view of the functional element from FIG. 9;

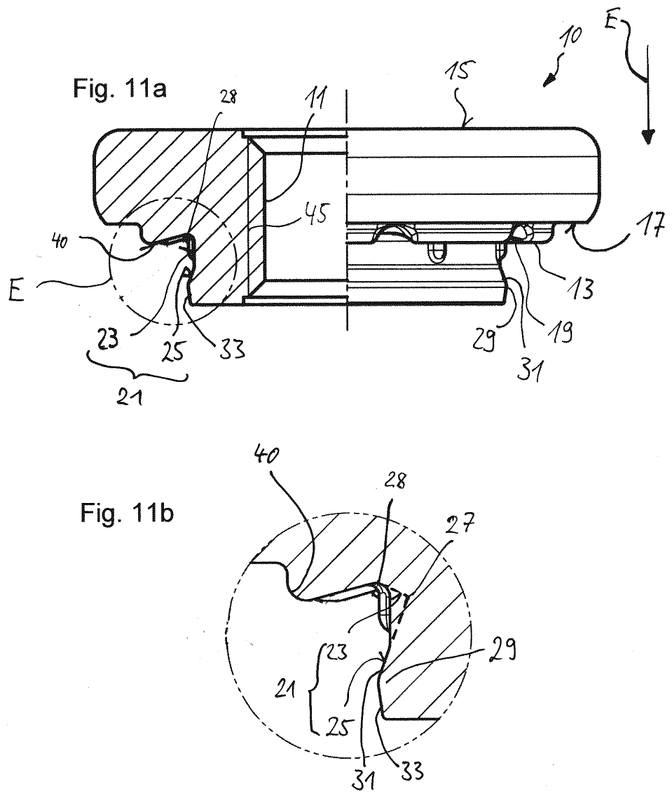

FIG. 11a shows a half-section of the functional element from FIG. 9;

FIG. 11b shows a detailed view of the region E in accordance with FIG. 11a;

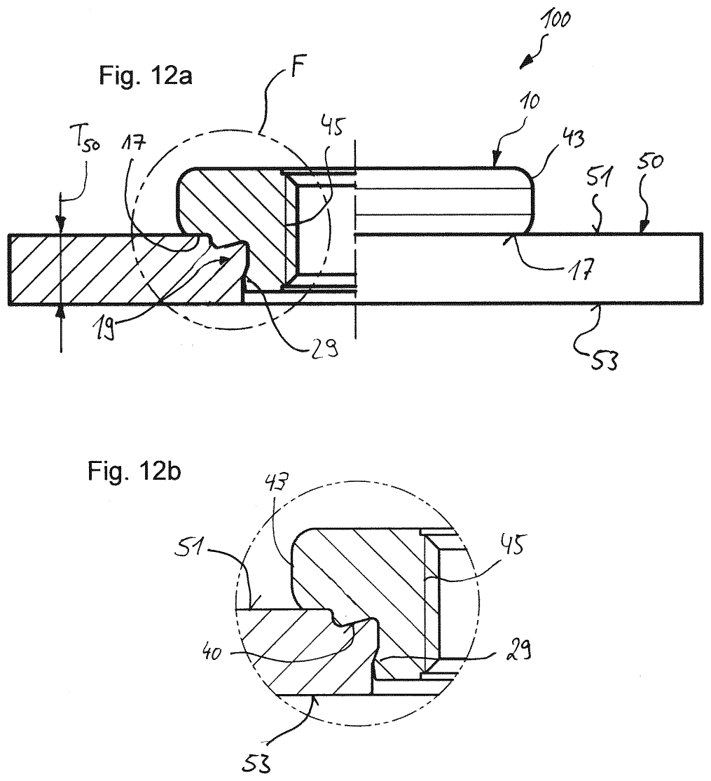

FIG. 12a shows a half-section of a component assembly in accordance with an embodiment example with a nut element as the functional element; and

FIG. 12b shows a detailed view of the region F in accordance with FIG. 12a.

A functional element 10 configured as a press-in bolt having a flange can be seen from FIG. 1 and FIG. 2 in each case and FIGS. 9 and 10 show a functional element 10 that is configured as a nut element, said functional elements 10 having a functional section 11 and a fastening section 13. The fastening section 13 is the section of the functional element 10 with which the functional element 10 is fastened to a workpiece 50 that will be described in more detail in the following. The functional elements 10 each have a head 43. The functional element 10 in accordance with FIGS. 1 and 2 that is configured as a press-in bolt also has a shaft 41 at which a thread 45 (external thread) is formed. An internal thread 45 (see FIG. 11a) is provided at the functional element 10 configured as a nut element.

The respective head 43 has an abutment surface 15 for introducing a press-in force into the functional element 10 and a flange-like workpiece contact surface 17 disposed opposite the abutment surface 15. In an axial direction and/or a radial direction of the functional element 10, a sealing region 19 is located between the workpiece contact surface 17 and the functional section 11, said sealing region 19 having a contact surface 21 for displaced material of the workpiece 50 to seal a connection between the functional element 10 and the workpiece 50.

The shaft 41 of the element 10 of FIGS. 1 and 2 extends from the side remote from the abutment surface 15. However, it is also possible to arrange the shaft at the abutment surface 15 (the abutment surface 15 would then be ring-shaped in the case of a shaft having a round cross-section). With an otherwise unchanged design of the fastening section 13, the sealing region 19 is then likewise disposed between the workpiece contact surface 17 and the functional section 11 in an axial view.

The design of the contact surface 21 is clearly shown in FIG. 3a to FIG. 5. The contact surface 21 comprises a conical first part surface 23, which extends obliquely to the axial direction of the functional element 10 and converges viewed in a press-in direction E of the functional element 10, and a conical second part surface 25 that, viewed in the press-in direction E, is disposed between the first part surface 23 and the functional section 11, that adjoins the first part surface 23 by means of a rounded transition region 27, that likewise extends obliquely to the axial direction of the functional element 10, and that diverges viewed in the press-in direction E of the functional element 10.

Specifically, the first part surface 23 can be inclined approximately 20° to approximately 40°, in particular approximately 30°, with respect to the axial direction and the second part surface 25 can be inclined approximately 50° to approximately 70°, in particular approximately 60°, with respect to the axial direction. As can, for example, be seen from FIG. 3b and FIG. 4, the two part surfaces 23, 25 can extend approximately at a right angle to one another. Alternatively, as shown in FIG. 5, the angle between the part surfaces 23, 25 can also be greater than 90°, for instance up to 135°.

As the embodiment example in FIGS. 11a to 12b clearly shows, the contact surface 21 of the functional element 10 designed as a nut element also comprises a first part surface 23 and a conical second part surface 25 that adjoins the first part surface 23 by means of a rounded transition region 27, that extends obliquely to the axial direction of the functional element 10, and that diverges viewed in the press-in direction E of the functional element 10. In the present example, the first part surface 23 extends approximately in parallel with the press-in direction E; however, the functional element 10 can also be designed such that the first part surface 23 extends obliquely to the axial direction and converges viewed in the press-in direction E, as indicated by dashed lines in FIG. 11b.

The press-in direction E in this respect designates the direction in which the functional element 10 is pressed into the sheet metal part 50 as intended. The press-in direction E extends in parallel with the axial direction of the functional element 10 from the abutment surface 15 in the direction of the workpiece contact surface 17, with the abutment surface 15 and the workpiece contact surface 17 extending approximately perpendicular to the press-in direction E.

The contact surface 21, and indeed the first part surface 23, extends into a (ring) recess 39 of the elements 10 formed in the head 43 in accordance with FIGS. 1 to 8b and merges there into the workpiece contact surface 17. A plurality of radially extending ribs are formed in the recess 39 as features providing security against rotation 37. The recess 39 is further directed opposite to the press-in direction E of the functional element 10 such that material of the workpiece 50 can at least partly be displaced on the pressing into the recess 39 and in so doing lies against the first part surface 23.

The element 10 in accordance with FIGS. 9 to 11b does not have this recess 39. Instead, a wedge-shaped elevated projection 40 is provided that slopes radially inwardly and merges into the first part surface 23 via a rounded transition section 28. In the embodiment example shown, the surface 23 has features providing security against rotation 37 in the form of axial ribs uniformly distributed in the peripheral direction. The elevated portion also preferably has features providing security against rotation 37, here as an example radial grooves uniformly distributed in the peripheral direction.

If required, the recess 39 described above and the elevated portion 40 can be combined—also in a modified form—and are implemented both in a nut element and in a bolt element.

The fastening section 13 furthermore comprises a projection 29 that extends peripherally radially outwardly and that bounds the sealing region 19 in the axial direction. The projection 29 has a first flank 31, which faces the sealing region 19 and at which the second part surface 25 of the contact surface 21 is formed, and a second flank 33 remote from the sealing region 19. Furthermore, the projection 29 of the functional element 10 configured as a press-in bolt has, unlike the nut element, an optional connection section 35 that connects the two flanks 31, 33 to one another. The diameter of the projection 29 varies along its axial extent and, viewed in the press-in direction E, increases in the region of the first flank 31, remains constant in the region of the connection section 35, and decreases in the region of the second flank 33. Accordingly, the flanks 31, 33 extend obliquely to the axial direction of the functional element 10.

As in particular FIG. 4 shows, the first flank 31 can be more inclined with respect to the axial direction than the second flank 33. On the one hand, a particularly effective design of the contact surface 21 and an effective undercut by the projection 29 hereby result. On the other hand, a comparatively slight positioning or inclination of the second flank 33 facilitates the insertion of the projection 29 into the shaped hole.

Alternatively thereto, the projection 29 can be of approximately symmetrical design, whereby an equal inclination of the flanks 31, 33 with respect to the axial direction (see, for example, FIG. 3b) results or the first flank 31 can be less inclined with respect to the axial direction than the second flank 33 as shown in FIG. 5, for example. Specifically, the first flank 31 can advantageously be inclined approximately 50° to approximately 70°, in particular approximately 60°, with respect to the axial direction and the second flank 33 can be inclined approximately 15° to approximately 35°, in particular approximately 25°, with respect to the axial direction.

The cooperation of the functional element 10 with the workpiece 50 can be clearly seen in particular from FIGS. 6a to 8b and FIGS. 12a and 12b that each show a component assembly 100 in accordance with the present invention. As shown, the workpiece 50 is in each case by way of example configured as a sheet metal part having preferably ductile properties. The workpiece 50 in each case has a surface 51 which the workpiece contact surface 17 of the functional element 10 contacts and a surface 53 at an oppositely disposed side of the workpiece 50. The workpiece 50 that is in each case shown in FIGS. 6a, 6b, 7a, 7b and 8a, 8b has increasing thicknesses T₅₀ to illustrate that the concept in accordance with the invention can be used with workpieces having the most varied properties.

The functional element 10 is in each case pressed into a shaped hole provided in the workpiece 50, for example a bore or a pre-punched hole, such that displaced material of the workpiece 50 and in the sealing region 19 and—if present—in the recess 39 is received and tightly contacts the contact surface 21. This is simplified by the oblique arrangement of the first part surface 23 since the material does not have to be pressed so deeply into the sealing region 19 to come into areal contact with said first part surface 23. In this respect, depending on the thickness T₅₀ of the workpiece 50, the displaced material of the workpiece 50 contacts the projection 29 (FIG. 6b, FIG. 8b, FIG. 12b) or even completely surrounds it (FIG. 7b). The functional element 10 in accordance with the invention thereby enables the manufacture of excellently sealed component assemblies 100, and indeed irrespectively of a thickness T₅₀ of the respective workpiece 50.

The following procedure can in particular be followed to manufacture the component assemblies 100 shown in FIG. 6a to FIG. 7b:

First, a functional element 10 in accordance with the invention and a workpiece 50, in particular a sheet metal part in which a shaped hole is formed, are provided. The functional element 10 is then inserted into the shaped hole such that the workpiece contact surface 17 faces the surface 51.

In this respect, a press-in force is introduced into the abutment surface 15 and causes the workpiece contact surface 17 to be brought into contact with the workpiece 50. This press-in force can be used such that material of the workpiece 50 is urged into the sealing region 19 and pressed against the contact surface 21. For this purpose, a die that is not shown in the Figures can be provided on the surface 53 remote from workpiece contact surface 17. Due to the press-in force, a punch of the die is pressed into the surface 53, wherein a ring groove 55 is formed in a region of the workpiece 50 adjoining the hole. Thus, the pressing of the punch of the die into the workpiece 50 into a region adjoining the hole thus displaces material of the workpiece 50 that flows into the sealing region 19 and in so doing lies against the contact surface 21.

It is generally also conceivable to first insert the element 10 into the workpiece 50 and to effect the step of displacing the material by means of the die in a separate and/or subsequent step.

In the component assembly 100 of FIGS. 8a, 8ab, the displacement of the material is not effected by a die having a punch, but the surface 53 of the workpiece 50 is rather disposed on a substantially planar support surface in the region around the hole. Here, the displacement of the material is effected by partially pressing the head 43 into the surface 51. Due to the planar support surface, the material cannot escape downwardly and is therefore urged into the sealing region 19 until it a really and thus tightly contacts the first part surface 23.

In the component assembly 100 in accordance with FIGS. 12a, 12ab, the displacement of the material is effected by the elevated portion 40. The head 43 is not pressed into the workpiece 50, but is merely pressed against its surface 51 until the workpiece contact surface 17 contacts it. In this respect, the elevated portion 40 penetrates the workpiece 50. Its radially inwardly sloping wedge shape supports a directed displacement of the material into the sealing region 19.

It is understood that the above-described concepts of the displacement of the material can be combined if it is useful in the respective application.

The embodiment examples shown and described here have in common that they provide a functional element or a component assembly that enable a sealed connection of a component assembly with little effort and without additional sealing means. Due to a suitable selection of the design, in particular a spatial arrangement, extent and/or inclination, of the first and second part surfaces, the first and second flanks, the transition section and/or the connection section, the functional element can be adapted to the respective conditions present.

The above embodiment examples relate to functional elements that can be inserted into pre-punched workpieces. However, it is also possible for these elements to be self-punching, in particular nut elements or bolt elements whose shafts extend from the abutment surface. Their fastening sections can for this purpose be provided with a punching edge facing the workpiece.

### REFERENCE NUMERAL LIST

10 functional element
11 functional section
13 fastening section
15 abutment surface
17 workpiece contact surface
19 sealing region
21 contact surface
23 first part surface
25 second part surface
27 transition region
29 projection
28 transition section
31 first flank
33 second flank
35 connection section
37 feature providing security against rotation
39 recess
40 elevated portion
41 shaft
43 head
45 thread
50 workpiece
51 surface
53 surface
55 ring groove
100 component assembly
E press-in direction
T₅₀ thickness of the workpiece

What is claimed is:

1. A functional element (10) for pressing into a workpiece (50), in particular into a sheet metal part, said functional element (10) comprising
a functional section (11); and
a fastening section (13) having
an abutment surface (15) for introducing a press-in force into the functional element (10);
a workpiece contact surface (17) that is disposed opposite the abutment surface (15), that can be brought into contact with the workpiece (50), and that is in particular of a flange-like design; and
a sealing region (19) for receiving displaced material of the workpiece (50), said sealing region (19) being disposed between the workpiece contact surface (17) and the functional section (11) in an axial direction and/or a radial direction of the functional element (10) and forming a contact surface (21) for the displaced material to seal a connection between the functional element (10) and the workpiece (50),
wherein the fastening section (13) has a projection (29) that bounds the sealing region (19) in the axial direction and that has a first flank (31) facing the sealing region (19) and a second flank (33) that is remote from the sealing region (19) and that extends obliquely and inclined to different degrees or equally inclined with respect to the axial direction,
wherein the first flank (31) is more inclined with respect to the axial direction than the second flank (33),
and wherein the second flank (33) is inclined approximately 15° to approximately 35° with respect to the axial direction.

2. A functional element (10) in accordance with claim 1
characterized in that the first flank (31) is inclined approximately 50° to approximately 70°, in particular approximately 60°, with respect to the axial direction.

3. A functional element (10) in accordance with claim 1
characterized in that the second flank (33) is inclined approximately 25° with respect to the axial direction.

4. A functional element (10) in accordance with any one of the claim 1
characterized in that the first flank (31) and the second flank (33) are connected to one another by a connection section (35) in which the projection (29) has a constant diameter.

5. A functional element (10) in accordance with any one of the claim 1
characterized in that the first flank (31) forms at least a part of the contact surface (21).

6. A functional element (10) in accordance with any one of the claim 1
characterized in that the fastening section (13), in particular the workpiece contact surface (17), has at least one feature providing security against rotation (37), preferably a plurality of features providing security against rotation (37).

7. A functional element (10) in accordance with claim 6,
characterized in that the features providing security against rotation (37) are formed as radially and/or axially extending ribs or grooves.

8. A functional element (10) in accordance with any one of the claim 1
characterized in that the workpiece contact surface (17) has a recess (39), in particular a ring recess, with the first part surface (23) preferably extending into the recess (39).

9. A functional element (10) in accordance with any one of the claim 1
characterized in that the workpiece contact surface (17) has an elevated portion (40), in particular with the elevated portion (40) being at least sectionally of wedge-shaped design viewed in a cross section, and/or in particular with the first part surface (23) merging into the elevated portion (40).

10. A functional element (10) in accordance with claim 1
characterized in that the workpiece contact surface (17) merges into the first part surface (23).

11. A component assembly (100) that has a workpiece (50), in particular a sheet metal part, and a functional element (10) in accordance with claim 1, wherein the functional element (10) is pressed into a hole prefabricated in the workpiece or into a hole punched by the functional element (10) such that material of the workpiece (50) displaced by the pressing in or after the pressing in is received in the sealing region (19) and tightly contacts the contact surface (21).

12. A component assembly in accordance with claim 11,
characterized in that the displaced material of the workpiece (50) contacts the projection (29) or at least partly or completely surrounds the projection (29).

13. A component assembly in accordance with claim 11
characterized in that a thickness (T₅₀) of the workpiece (50) is smaller than or substantially equal to an axial extent of the sealing region (19) at least in the region of the hole.

14. A component assembly in accordance with claim 11
characterized in that a thickness (T₅₀) of the workpiece (50) is greater than or substantially equal to an axial extent of the sealing region (19) at least in the region of the hole.

15. A method of manufacturing a component assembly (100) in accordance with claim 11, comprising the steps:
providing a functional element (10) in accordance with claim 1;
providing a workpiece (50), in particular a sheet metal part; and
inserting the functional element (10) into a prefabricated hole in the workpiece or into a hole punched by the functional element (10) and introducing a press-in force into the abutment surface (15) such that the workpiece contact surface (17) is brought into contact with the workpiece (50); and
displacing material of the workpiece (50) into the sealing region (19) such that the material is pressed against the contact surface (21) to establish a sealed connection between the functional element (10) and the workpiece (50).

16. A method of manufacturing a component assembly (100) in accordance with claim 15, further comprising the step:
pressing a die against a surface (53) of the workpiece (50) remote from the workpiece contact surface (17) to displace material of the workpiece (50) into the sealing region (19) such that the material is pressed against the contact surface (21) to establish a sealed connection between the functional element (10) and the workpiece (50).
